(19) United States
(12) Patent Application Publication
(10) Pub. No.: US 2026/0055606 A1
(43) Pub. Date: Feb. 26, 2026

(54) COMPOSITE PLASTER PANELS AND COMPOSITIONS AND METHODS FOR MANUFACTURING COMPOSITE PLASTER PANELS

(71) Applicant: HYDROBLOK, INC., Park City, UT (US)

(72) Inventors: Zhongsheng CHEN, Draper, UT (US); Brian DUNN, Draper, UT (US); Alex GILLESPIE, Draper, UT (US)

(21) Appl. No.: 19/306,817

(22) Filed: Aug. 21, 2025

Related U.S. Application Data
(60) Provisional application No. 63/686,489, filed on Aug. 23, 2024.
(60) Provisional application No. 63/692,563, filed on Sep. 9, 2024.

(51) Int. Cl. E04C 2/288; B32B 3/02; B32B 5/18; B32B 13/04; C04B 14/28; C04B 14/30; C04B 24/38; C04B 28/18; C04B 103/30; C04B 103/50; C04B 111/00; C09D 175/02; C09D 177/04; E04B 2/00

(52) U.S. Cl. CPC E04C 2/288; B32B 3/02; B32B 5/18; B32B 13/045; C04B 14/28; C04B 14/308; C04B 24/383; C04B 28/18; C09D 175/02; C09D 177/04; B32B 2260/021; B32B 2260/044; B32B 2266/04; B32B 2307/7376; B32B 2607/00; C04B 2103/302; C04B 2103/50; C04B 2111/00612; E04C 2/46

(57) ABSTRACT

Composite plaster panels, compositions used to make composite plaster panels, and methods for manufacturing composite plaster panels. Composite plaster panels include a core composite panel structure and a plaster layer applied to and at least partially covering at least one side of the core composite panel structure. The core composite panel structure includes a foam core sandwiched between thin protective layers (e.g., fiber mesh reinforced cementitious layer or thermoset polymer layer). The plaster layer includes reaction products of water, Portland cement, preferably, white cement, calcium carbonate, aluminum oxide, silicon dioxide, cellulose ether, and latex. The composite plaster panels can be used to replace gypsum drywall panels and are advantageously lighter weight, have beveled edges, and can have a smooth or textured plastic layer. The composite plaster panels can be cut, drilled, and screwed onto structural elements of buildings, such as wall frames comprising wooden or metal studs or ceiling joists.

### CROSS-REFERENCE TO RELATED APPLICATIONS

This application claims the benefit of U.S. Provisional Application No. 63/692,563, filed Sep. 9, 2024, and U.S. Provisional Application No. 63/686,489, filed Aug. 23, 2024, which are incorporated by reference in their entirety.

### BACKGROUND

### Technical Field

This disclosure relates to composite plaster panels, such as interior wall panels that substitute for drywall, and compositions and methods for making composite plaster panels.

### Related Technology

Houses and other buildings are typically constructed using wood or metal studs to form a three-dimensional wall frame, which can include an interior wall on one side and an exterior wall on the other. Alternatively, both sides can be interior walls, such as interior walls separating rooms or walls dividing attached dwelling units such as apartments, town houses, and condominiums. Interior walls of houses and other buildings are typically formed using drywall (e.g., gypsum board) to form a generally flat underlying wall surface, which can be painted, wallpapered, or treated with other desired finishes.

Drywall is used for interior walls and ceilings in buildings and is a replacement for old fashioned lath and plaster systems. A drywall panel typically consists of a layer of gypsum plaster (CaSO₄·2H₂O) sandwiched between two layers of paper. Raw gypsum (CaSO₄·2H₂O) is heated to drive off the water and slightly rehydrated to produce calcium sulfate hemihydrate (CaSO₄·½H₂O) plaster, also known as plaster of Paris. Plaster of Paris is typically mixed with fiber (e.g., paper and/or glass fiber), plasticizer, foaming agent, finely ground gypsum crystals as accelerator, EDTA, starch or other chelate as retarder, and various additives that can increase mildew and fire resistance, lower water absorption (e.g., wax emulsion or silanes), and reduce creep (e.g., tartaric or boric acid). The drywall board or panel is formed by sandwiching a core of wet plaster with additives between two sheets of heavy paper or fiberglass mats. When the plaster has set, the drywall panel is dried in a large drying chamber to form a rigid panel strong enough for use as a building material.

As an alternative to a week-long plaster application, an entire house can be drywalled in one or two days by experienced drywallers and even amateur home carpenters. Joints between drywall panels are typically covered with tape and a thin layer of drywall patch. Special finishes can be applied for texture, and the drywall is typically primed and painted and/or wallpapered to yield a finished wall.

Gypsum drywall is not water resistant and is not recommended for applications where it can be exposed to water and high humidity environments. Although interior drywall is typically not intended to be exposed to water, accidents can occur, such as a broken water pipe. Water can irreversibly damage gypsum drywall panels, requiring tear-out and replacement following water damage. Drywall is highly vulnerable to moisture due to the inherent properties of the materials that constitute it: gypsum, paper, and organic additives and binders. Gypsum will soften with exposure to moisture and eventually turn into a gooey paste with prolonged immersion, such as during a flood or even in a bathroom when exposed to excessive water. Following water damage, some or all of the drywall will likely need to be removed and replaced. Furthermore, the paper facings and organic additives mixed with the gypsum core are can promote mold growth, which is unsightly and unhealthy

Another issue is fire and thermal resistance. While gypsum drywall can provide a level of fire and heat resistance, multiple layers or thick assemblies are often required, increasing weight, material use, cost and labor. Gypsum-based panels are highly susceptible to water damage, mold growth, and structural degradation in high-humidity environments or areas prone to water leaks. Gypsum-based shaft liners offer limited thermal resistance, reducing energy efficiency in walls exposed to external temperature differentials.

Another issue with gypsum board is the outer surface is paper, which appears unfinished and requires application thereto of one more finishing layers, such as paint and/or wallpaper. While paint and wallpaper can readily adhere to the paper surface of gypsum board, some builders and homeowners will apply a thin plaster coating layer (e.g., skim coat) over the paper layer to reinforce the drywall and provide a more even and durable surface to which a finish can be applied.

Another issue with traditional gypsum wallboards is their tendency to warp, have surface imperfections, or otherwise have defects that make them non-planar. As a result, it is often necessary to “float” tile and other surface finishes using thin set mortar to yield a planar finish. In the event that a planar wall surface (e.g., “level 5” surface) is required, such as when the surface finish includes paint, wallpaper, or other pristine wall finish that may expose non-planar defects, it will typically be necessary to fill in surface defects and warping using plaster, which can be expensive and time consuming.

Accordingly, there remains a need for improved wall panels that can substitute for gypsum drywall panels, which are waterproof, are heat resistance, provide high strength, yet remain lightweight to facilitate installation.

### SUMMARY

Disclosed are composite plaster panels and compositions and methods for manufacturing composite plaster panels. The composite plaster panels can be used in place of gypsum drywall for making interior walls and are advantageously strong, lightweight, and moisture and heat resistant. The composite plaster panels can have a plaster show layer (i.e., that faces outwardly) having a desired surface finish, such as smooth or textured.

The composite plaster panels comprise a core composite panel structure over which a plaster layer has been applied. The core composite panel structure comprises a lightweight foam core sandwiched between first and second protective layers, such as a fiber mesh reinforced cementitious composition and/or cured thermoset resin or other rigid material. The plaster layer can be applied over one or both sides of the core composite panel structure to yield composite plaster panels of desired construction and functionality.

The composite plaster panels can be used to form interior wall structures. In some embodiments, the outer/exposed surface of the core composite panel structure and optionally the side edges can be covered by the plaster layer. The interior surface of the composite plaster panel (i.e., that faces inwardly) can omit a plaster layer and have a textured surface that facilitates the use of glue or other adhesives to attach composite plaster panels to structural elements of a building. such as interior wall studs or ceiling joists.

The composite plaster panels can be cut, drilled, screwed, or glued onto structural elements of buildings, such as interior wall studs or ceiling joists. The composite plaster panels are advantageously lightweight yet strong and able to support relatively heavy loads, such as pictures or other items attached using nails or other hangers or wall-mounted televisions attached using screws or other wall attachment systems. The composite plaster panels can be moisture-resistant (e.g., waterproof) and heat-resistant (e.g., fire resistant), and have high structural strength (e.g., high tensile strength, flexural strength, and/or toughness).

Because the core composite panel structure comprises a strong lightweight foam core sandwiched between two fiber mesh reinforced cementitious (or other rigid protective) layers, and because the plaster layer applied to the core composite panel structure can be thin and lightweight, the composite plaster panels disclosed herein are both lighter weight and stronger than conventional gypsum wallboard. Moreover, the core composite panel structure and plaster layer can be waterproof, providing extra safety if the composite plaster panels are inadvertently exposed to moisture. The plaster layer is typically made from a cementitious plaster composition comprised of hydraulic cement, calcium carbonate, water, and other components, which can harden and cure to become strong and water-resistant. In some embodiments, the composite plaster panels can include beveled edges (e.g., 2 or 4) to permit placement of multiple adjacent composite plaster panels to a wall to form beveled joints, followed by the application of drywall patch (taping and mudding) to hide the beveled joints.

In some embodiments, the fiber mesh reinforced cementitious (or other rigid protective) layer of the core composite panel structure can have a grid pattern or other texture or discontinuities that may be desirably smoothed out by the plaster layer in order to yield composite plaster panels having a smooth surface, at least on the show side that is intended to receive a subsequent finish, such as paint or wallpaper. Alternatively, the plaster layer can have a textured surface or other non-smooth finish to provide a desired look or functionality (e.g., old world or traditional lath and plaster look).

Additional features and advantages will be set forth in part in the description that follows, and in part will be obvious from the description, or may be learned by practice of the embodiments disclosed herein. It is to be understood that both the foregoing brief summary and the following detailed description are exemplary and not restrictive of the embodiments disclosed herein or as claimed.

### BRIEF DESCRIPTION OF THE DRAWINGS

Various objects, features, characteristics, and advantages of the invention will become apparent and more readily appreciated from the following description of the embodiments, taken in conjunction with the accompanying drawings and the appended claims, all of which form a part of this specification. In the Drawings, like reference numerals may be utilized to designate corresponding or similar parts in the various Figures, and the various elements depicted are not necessarily drawn to scale, wherein:

FIG. 1A is a side perspective view that illustrates examples of different sizes of core composite panel structures, which can be modified to form composite plaster panels;

FIG. 1B is a top perspective view that illustrates the differently-sized core composite panel structures of FIG. 1A;

FIG. 2 is an exploded diagram that schematically illustrates the layered structure of the core composite panel structures of FIGS. 1A and 1B;

FIG. 3 is a perspective view that illustrates an example composite plaster panel, with the different layers being visible, including a textured finish layer;

FIGS. 4A-4C illustrate an example composite plaster panel, with the different layers being visible, including a smooth finish layer;

FIG. 5 is a perspective view that schematically illustrates an embodiment of a composite plaster panel with a bevel extending to each of the four edges;

FIG. 6A is a cross-sectional view that schematically illustrates the layered structure of an embodiment of a composite plaster panel with beveled edges;

FIG. 6B is an exploded diagram that schematically illustrates the layered structure of the composite plaster panel of FIG. 6A;

FIG. 7A is a cross-sectional view that schematically illustrates the layered structure of another embodiment of a composite plaster panel with beveled edges;

FIG. 7B is an exploded diagram that schematically illustrates the layered structure of the composite plaster panel of FIG. 7A;

FIG. 8A illustrates a pair of composite plaster panels abutting each other, with beveled edges forming a channel or depression that can be filled with tape and drywall patch during installation;

FIG. 8B is a photograph showing a pair of composite plaster panels abutting each other, with the beveled edges covered by drywall patch or plaster; and

FIG. 9 schematically illustrates an apparatus for grinding or trimming bevels in a core composite panel structure before applying the plaster layer.

### DETAILED DESCRIPTION

### I. Overview

Disclosed are composite plaster panels that are advantageously strong, lightweight, moisture resistant, and heat resistant. Also disclosed are compositions and methods for manufacturing composite plaster panels. The composite plaster panels include a core composite panel structure comprised of a lightweight foam core sandwiched between first and second protective layers of fiber mesh reinforced cementitious composition or other rigid protective material. A plaster layer is applied over one or both sides of the core composite panel structure to yield composite plaster panels. The plaster layer is typically applied as a flowable cementitious composition to at least one side of the core composite panel structure and caused or allowed to harden and cure. The composite plaster panels can be cut, drilled, and screwed, nailed, or glued onto structural elements of buildings, such as interior wall studs or ceiling joists.

### II. Core Composite Panel Structure

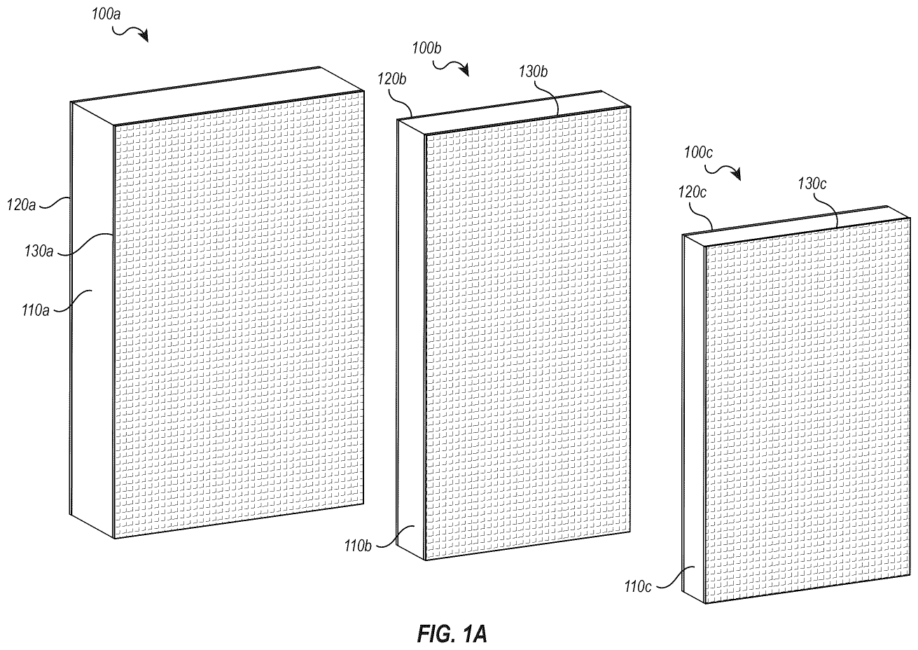

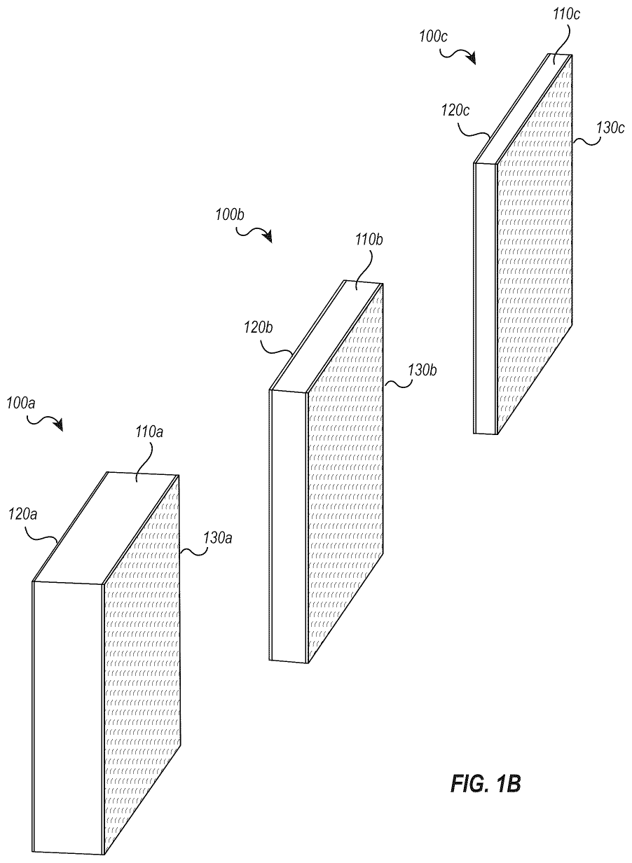

Reference is made to FIGS. 1-2. FIGS. 1A and 1B illustrate core composite panel structures 100a, 100b, 100c of varying cross-sectional thickness that can be modified by application of one or more plaster layers to yield composite plaster panels of the disclosure. FIGS. 1A and 1B show the layered structure of core composite panel structures 100a, 100b, 100c, including strong, lightweight, and moisture-resistant extruded polystyrene (XPS) foam cores 110a, 110b, 110c sandwiched between first fiber mesh reinforced cementitious layers 120a, 120b, 120c and second fiber mesh reinforced cementitious layers 130a, 130b, 130c. As discussed below, in other embodiments the foam core may comprise other polymer or inorganic foam materials, and one or both protective layers may comprise a thermoset polymer or other rigid protective material.

The cross-sectional thickness of the core composite panel structures 100a, 100b, 100c can be selected based on a combination of desired properties for their intended use to make composite drywall boards, such as strength, insulation, spacing between wall elements and the like. As illustrated in FIGS. 1A and 1B, the cross-sectional thicknesses of the core composite panel structures 100a, 100b, 100c varies mostly or entirely depending on the cross-sectional thickness of the foam cores 110a, 110b, 110c. Although not shown, when core composite panel structures 100 of greater cross-sectional thickness are desired, it may be desirable to increase the thickness of the fiber mesh reinforced cementitious layers 120, 130 (e.g., to account for possible strength reduction caused by including a foam core 110 of greater cross sectional thickness).

FIG. 2 is in an exploded view that schematically illustrates the layered structure of a core composite panel structure 200, which is similar or identical to the core composite panel structures 100a, 100b, 100c of FIGS. 1A and 1B. The foam core 210 can be a lightweight polymer foam made from closed cell extruded polystyrene (XPS), is lightweight, rigid, waterproof, thermally insulating, and includes two outer surfaces or faces. In some embodiments, the foam core 210 may have a density of about 30-45 kg/m³ and a compressive strength of about 250-400 kPa.

Alternatively, the foam core 110, 210 can be made from a different polymer foam material, such as, but not limited to, expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. An advantage of thermoset polymer foam materials is they are generally more fire- and heat-resistant than thermoplastic polymers, with thermoset phenolic polymers in particular providing a high level of fire and heat resistance.

The properties of various polymers that can be used to make foam core layers 110, 210 are set forth in Tables 1-3.

TABLE 1

| Property | XPS/EPS | Phenolic | |
|---|---|---|---|
| Material Type | Thermoplastic | Thermoset (phenol- | |
| | polystyrene | formaldehyde) | |
| Thermal Conductivity (W/m · K) | 0.028-0.033 | 0.018-0.022 | |
| R-Value per inch | ~5.0 | 6.5-7.2 | |
| Fire Resistance | Poor - melts, drips | Excellent - chars, low | |
| | | smoke | |
| Flame Spread (ASTM E84) (W/O Facer | 75-200 | <25 (Class A) | |
| Smoke Development (W/O Facer) | >450 (often) | <50 | |
| Thermal Stability | ~93° C. (melts) | 150-175° | C. |
| Water Resistance | Excellent | Good (closed-cell) | |
| Compressive Strength | 200-300 kPa | 100-150 | kPa |

| | | |
|---|---|---|
| Flexural Strength | Flexible, good | Brittle |
| Recyclability | Yes (thermoplastic) | No |
| Weight (kg/m³) | 25-35 | 35-50 |
| Cost | Low-Moderate | High |

TABLE 2

| Property | Melamine | PUR | |
|---|---|---|---|
| Material Type | Thermoset (melamine- | Thermoset (polyol + | |
| | formaldehyde) | isocyanate) | |
| Thermal Conductivity (W/m · K) | 0.032-0.036 | 0.020-0.025 | |
| R-Value per inch | ~4.1-4.5 | ~6.0-6.5 | |
| Fire Resistance | Excellent - non- | Poor - needs FR | |
| | melting, self- | additives | |
| | extinguishing | | |
| Flame Spread (ASTM E84) (W/O Facer | <25 (Class A) | Varies (often >25) | |
| Smoke Development (W/O Facer) | Very low | High | |
| Thermal Stability | ~240° C. | ~100-120° | C. |
| Water Resistance | Poor unless sealed | Good | |
| Compressive Strength | Low | 150-300 | kPa |

| | | |
|---|---|---|
| Flexural Strength | Very brittle | Strong |
| Recyclability | Limited | No |
| Weight (kg/m³) | 7-12 | 30-45 |
| Cost | High | Moderate |

TABLE 3

| Property | Polyiso | |
|---|---|---|
| Material Type | Thermoset (polyisocyanurate) | |
| Thermal Conductivity (W/m · K) | 0.020-0.023 | |
| R-Value per inch | ~6.0-6.5 | |
| Fire Resistance | Good - chars, often Class A | |
| | with facer | |
| Flame Spread (ASTM E84) (W/O Facer | <25 (Class A with facer) | |
| Smoke Development (W/O Facer) | <150 | |
| Thermal Stability | ~150° | C. |
| Water Resistance | Fair (can degrade if | |
| | unprotected) | |
| Compressive Strength | 140-200 | kPa |

| | |
|---|---|
| Flexural Strength | Moderate |
| Recyclability | Rarely recycled |
| Weight (kg/m³) | 30-42 |
| Cost | Moderate-High |

With reference to FIG. 2, formed over first and second outer surfaces of the foam core 210 are first and second layers of fiber (e.g., fiberglass) mesh 220b, 230b, respectively, which become embedded within respective first and second layers of fresh cementitious composition applied over the fiber mesh layers 220b, 230b, which harden or cure to form first and second cementitious layers 220a, 230a. Together, the hardened cementitious layers 220a, 230a and embedded fiberglass mesh layers 220b, 230b form first and second fiber mesh reinforced cementitious layers 220, 230, which adhere to the foam core 210 to form a strong but lightweight core composite panel structure. The fiber mesh layers 220b, 230b can alternatively include other fibers or filaments, such as carbon fibers or filaments.

The lightweight foam core is typically made from extruded polystyrene foam (XPS), but can alternately comprise expanded polystyrene foam (EPS), polyisocyanurate foam, polyurethane (PUR) foam, phenolic polymer (e.g., phenol-formaldehyde) foam, melamine polymer (e.g., melamine-formaldehyde) foam, and/or other thermoplastic or thermoset polymer known in the art that can be formed into rigid or semi-rigid foam layers. The lightweight foam core can be made of closed cell polystyrene foam to provide a water-resistant barrier (e.g., 100% waterproof).

Alternatively, the foam core may comprise an inorganic foam, such as a refractory foam material, to provide additional fire-resistance. Examples include silica gel, aerogel, silicate foams, urea-silicate foam, SiOC/SiC, ceramic foams, refractory foams, and the like. The inorganic foam core can resist melting even when exposed to fire or intense heat in order for the core composite panel structure to maintain its structural integrity.

In some embodiments, the core composite panel structures are manufactured by applying a fiber (e.g., fiberglass) mesh and fresh cementitious composition onto first and second surfaces of a rigid polymer (e.g., XPS) or inorganic foam core and causing or allowing the applied cementitious composition to harden. The fiber mesh becomes embedded in the hardened cementitious layer to enhance strength, increase toughness, and prevent cracking of the hardened cementitious layer. Alternatively, at least one of the hardened cementitious layers can be replaced or augmented with a cured polymer layer.

The layers of fiber mesh reinforced cementitious composition are generally “thin” (e.g., typically less than about 3 mm, less than about 2.5 mm, less than about 2 mm, or less than about 1.5 mm, such as about 1 mm, or between about 0.5-3 mm, about 0.75-2.5 mm, about 1-2 mm, or about 1.25-1.75 mm in cross-sectional thickness). The fiber mesh reinforced cementitious layers can be very lightweight yet waterproof and have high structural strength (i.e., high tensile and flexural strength and high toughness). The fiber mesh component is typically fiberglass fiber or glass filament mesh, but can be made of other strong fibers or filaments, such as carbon fibers or filaments. In some embodiments, fiberglass mesh is formed of an alkali-resistant material and may have nominal mesh size of 4×4 mm with a strand diameter of about 0.5-1.0 mm.

In the case where it is desired for composite plaster panels to have beveled edges (e.g., to accommodate mesh tape and wall patch to join adjacent composite plaster panels together), the fiber mesh reinforced cementitious layer of the core composite panel structure can be applied before or after forming beveled edges in the form core when forming the core composite structure. To maximize strength and performance, the fiber mesh reinforced cementitious (or other rigid) layer can be applied after forming beveled edges in the foam core to create a continuous fiber mesh reinforced cementitious (or other protective) layer across the entire surface of the core composite panel structure before applying the plaster layer.

In some embodiments, the fresh cementitious composition comprises mixture products of water, hydraulic cement, silicon dioxide powder, calcium oxide, iron oxide, plaster of Paris (gypsum hemihydrate), water-reducing agent, defoamer, styrene, and acrylic acid. The fresh cementitious composition may optionally include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The cementitious composition may include other components, such as natural hydraulic lime, calcium silicate, and/or expanded glass, which can increase fire and heat resistance.

In a more particular embodiment, the cementitious composition applied to the outer surfaces of the foam core to form fiber mesh reinforced cementitious layers of the core composite panel structures can be formed by mixing together the following components (expressed in weight percent) to form a fresh flowable cementitious composition, which is applied to the foam core surfaces, together with fiber mesh, and then allowed to harden or cure:

| | |
|---|---|
| Hydraulic cement | 30-50% |
| Silicon dioxide | 40-60% |
| Calcium oxide | 2-5% |
| Iron oxide | 0.2-1% |
| Gypsum hemihydrate | 3-8% |
| Water-reducing agent | 0.2-0.6% |
| Defoamer | 0.2-0.6% |
| Styrene | 1-2% |
| Acrylic acid | 1-2% |
| Water | (16-20%, preferably 18.4% |
| | dry ingredients above) |

The hydraulic cement typically includes Portland cement clinker interground with gypsum for set control, but may also include other interground minerals, such as limestone filler (e.g., 5-10% by weight of the hydraulic cement), and optionally one or more supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The silicon dioxide can be 150 mesh ground quartz sand. The water reducer can be a low-range water reducer, such as a compound of carboxylic acid grafted multi-polymer and other effective additives. The defoamer can reduce the surface tension of water, solution, suspension, etc., prevent the formation of foam, or reduce or eliminate the original foam. The main component of the defoamer can be polydimethylsiloxane (Me₃SiO(Me₂SiO)nSiMe₃) (Me=methyl). In the case where very fine SCMs (e.g., silica fume, microsilica, or metakaoline), it may be desirable to use a high range water reducer (e.g., polycarboxylate ether) to obtain good flow. The styrene and acrylic acid components, which may be a copolymer, can form a chemical bond to the extruded polystyrene foam core, in addition to the physical bond.

The components of the cementitious composition can be mixed by high-performance mixing equipment through precise batching, and then fed into a mixing barrel in sequence for high-speed dispersion and mixing, thus yielding a fresh cementitious mixture. The fresh cementitious mixture is blended in a tank to make it into liquid or plastic form. The liquid cementitious mixture is then pumped into a machine variously called a “waterfall machine,” commonly known as a “curtain coater” or enrobing “coater/machine”, which has flow control of the liquid cementitious mixture and which will apply the liquid cementitious mixture onto surfaces of an extruded polystyrene foam sheet or other material to be coated. The liquid cementitious mixture is applied like a waterfall or curtain through a blade applicator to evenly apply it to the polymer foam surfaces or other surface to be coated. The product is then cured and left to stand for approximately 7 days as usual practice. However, if ambient conditions are dry and hot, the curing period could be shortened to approximately 3-4 days.

In general, the hardened fiber mesh reinforced cementitious composition can adhere and bond strongly to the polymer or inorganic foam core to form a strong core composite panel structure that does not delaminate. The bond between the cementitious layers and the foam layer is likely a combination of physical and chemical interactions. When applied to the polymer or inorganic foam layer, the liquid cementitious composition can penetrate into surface pores of the foam layer, which upon hardening of the cementitious composition, forms a strong mechanical bond. This bond can be further enhanced through the inclusion of very fine pozzolans, such as silica fume, microsilica, or metakaoline on the cementitious composition, which creates a very high strength cementitious layer and are able to fill very small micropores. The polymer components of the cementitious composition may also interact with components of the foam layer to form a type of chemical bond between the cementitious layers and the foam (e.g., polymer) layer. Regardless of how bonding occurs, it is demonstrably very strong and does not delaminate during specified use. Curable resins also adhere and bond strongly to the foam core.

In some embodiments, when manufacturing the core composite panel structure, the fiberglass mesh is first laid down on a polymer (e.g., extruded polystyrene) or inorganic foam sheet. A transportation belt then transports the foam sheet with the fiberglass mesh through the waterfall machine (commonly known as a “curtain coater” or enrobing “coater/machine”), which causes the liquid cementitious mixture to flow down like a waterfall or curtain, with control of the liquid cementitious mixture flow, onto the foam sheet or other substrate. In this way, the fiberglass mesh becomes embedded in the liquid cementitious mixture and essentially floats in the middle of the cementitious mixture. In other words, a portion of the liquid cementitious mixture will be positioned between the fiberglass mesh and the foam sheet in order to directly adhere to the foam sheet, and another portion of the liquid cementitious mixture will cover and encapsulate the fiber mesh to form the top surface of the core composite tile structure. The result is a layered composite core structure, with an interior polymer or inorganic foam sheet, an underlying layer of cementitious composition in direct contact with the foam sheet, a fiberglass mesh in the middle, and a top layer of cementitious composition covering the fiberglass mesh.

In addition to, or instead of, a fiber mesh reinformed cementitious layer, one or both protective layers of the composite core panel structure may comprise other materials in addition to or instead of the cementitious composition. Examples include one or more of rigid magnesium oxide material, water-resistant polymer, or a composite material comprising a resin or polymer with embedded fibers, fiber mesh, fabric, scrim, felt, or non-woven. The material forming the fibers, fiber mesh, fabric, scrim, felt, or non-woven can be selected from plant fibers, polymer fibers, and inorganic fibers (e.g., basalt, rock wool, and the like). The resin or polymer may comprise a thermoplastic or thermoset material, such as UV-cured resins, polypropylene, polycarbonate, polyethylene terephthalate, polystyrene, acrylate, methacrylate, polyurea, polyaspartic, or epoxy. Protective layers of thermoset polymer can be slightly thicker than fiber mesh reinforced cementitious layers, such as between about 1-5 mm or about 2-3 mm.

Polyurea is a type of elastomer that is derived from the reaction product of an isocyanate component and an amine component. The isocyanate can be aromatic or aliphatic in nature. It can be monomer, polymer, or any variant reaction of isocyanates, quasi-prepolymer or a prepolymer. The prepolymer, or quasi-prepolymer, can be made of an amine-terminated polymer resin, or a hydroxyl-terminated polymer resin. The resin blend can include amine-terminated polymer resins and/or amine-terminated chain extenders. The resin blend may also contain additives or non-primary components, such as pigments pre-dispersed in a polyol carrier. Normally, the resin blend does not contain a catalyst. This is because the reaction between an isocyanate and amine is extremely fast and hence does not need catalysis.

The chemical structure of polyurea is as follows:

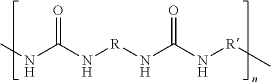

In a polyurea, alternating monomer units of isocyanates and amines react with each other to form urea linkages, as shown below.

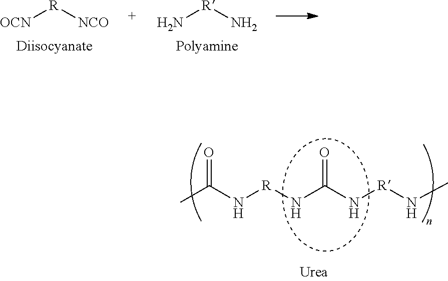

Polyaspartic resin is a solvent-free, aliphatic amine coating material based on aspartic acid, polyaspartic acid, or polyaspartic ester, which reacts with an isocyanate to create extremely durable protective coatings with rapid cure times, excellent abrasion resistance. An example of a curable polyaspartic resin has the following reactants and final cured polymer structure:

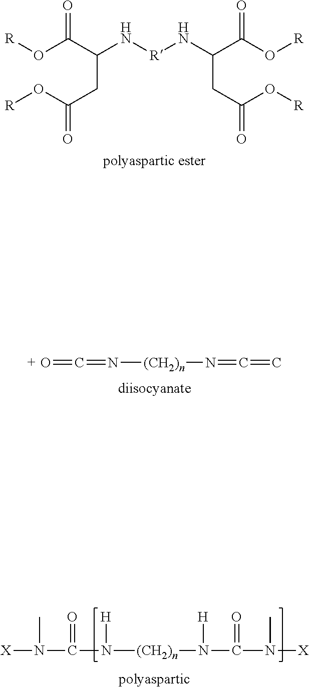

The curable resin can be applied by spray coating while in a flowable state to one or both surfaces of the foam core and allowing it to cure and form a solid protective layer. Multiple parts of the curable resin can be mixed just prior to entering or within the nozzle used to spray coat the foam core. Where it is desired to incorporate a fiberglass mesh sheet in the polymer layer, an initial coating of curable resin can be applied to the foam core, followed by applying the fiberglass mesh sheet over the resin, followed by applying a final coating of the curable resin.

In some embodiments, the outlines of the fiberglass mesh embedded within the hardened cementitious or cured resin layer can be visible and form a grid-like texture that improves adhesion of structural and/or decorative materials thereto, such as the plaster layer. The core composite panel structures can be rectangular in shape, with a constant cross sectional thickness and essentially planar surfaces. Alternatively, the core composite panel structure can have beveled edges. Prior to forming the beveled edges, the foam core can be rectangular in shape, with a constant cross-sectional thickness. Beveled edges can be formed by cutting or grinding the sides of the foam core.

### III. Composite Plaster Panels

In order for composite plaster panels to function as an interior drywall replacement, such as where it may be desired to apply an interior finish, such as paint, wallpaper, or molding (e.g., wainscot, wood paneling, or crown molding), the core composite panel structures described herein are modified to include a plaster layer applied over at least one of the fiber mesh reinforced cementitious (or other protective) layers. The plaster layer can be generally white in color, although other colors are possible if desired.

Composite plaster panels can include a light colored (e.g., white or off white) plaster layer bonded over at least the exterior surface of the exterior fiber mesh reinforced cementitious (or other protective) layer, and optionally the side edges, giving the composite plaster panels the appearance of plaster board without paper. Because composite plaster panels can include fiber mesh reinforced cementitious (or other protective) layers, along with a waterproof interior polymer foam core, they are both waterproof and substantially stronger than conventional gypsum drywall panels. The composite plaster panels can be used, for example, in embodiments where it is desired to construct a complete wall structure that includes two interior walls or, alternatively, an interior wall and an exterior wall made with lightweight composite wallboards to which an exterior finish is applied, such as in U.S. Provisional Application No. 63/744,115, filed Jan. 10, 2025, and U.S. Provisional Application No. 63/729,637, filed Dec. 9, 2024, which are incorporated by reference in their entirety. They can be used to make shaft liners, such as in U.S. Provisional Application No. 63/747,543, filed Jan. 21, 2025, which is incorporated by reference in its entirety.

The composite plaster panels include a lightweight foam core sandwiched between two fiber mesh reinforced cementitious (or other protective) layers, but with an additional plaster coating applied on at least one protective layer to provide a plaster finish to yield panels that can substitute for gypsum drywall panels. The plaster layer can be textured, sanded, painted, wallpapered, and the like, similar to the surface of conventional gypsum wallboard. However, the plaster layer can have a desired surface finish that eliminates the requirement to apply a finish to the paper surface of conventional gypsum drywall panels. The composite plaster panels can be attached to wood or metal studs or other wall or ceiling structural elements using screws, nails, adhesives, or other known attachment means. The composite plaster panels can also include bevels (e.g., 2 or 4) to permit placement of multiple adjacent composite plaster panels, followed by application of drywall patch (taping and mudding) to hide the joints. Specialized connectors, such as washers with enlarged surfaces and penetrating prongs can be used to join adjacent lightweight composite drywall boards together, as disclosed in U.S. Provisional Application Nos. 63/744,115 and 63/729,637 discussed above.

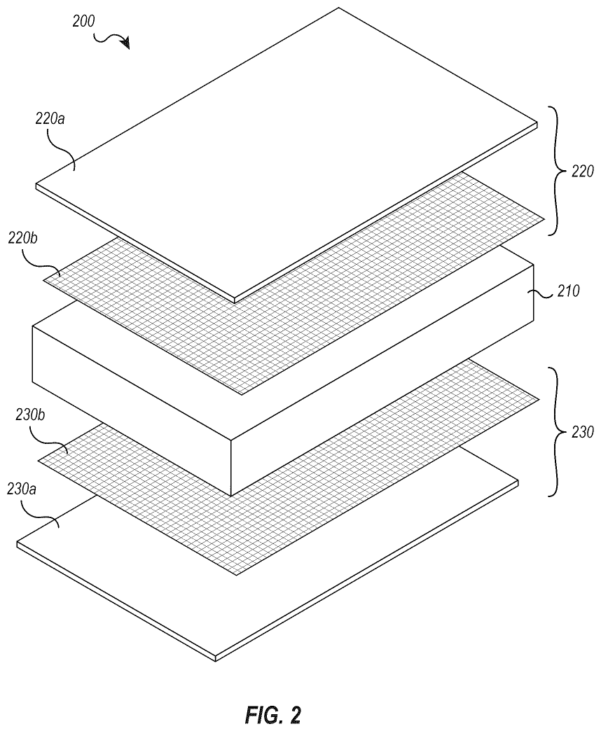

Reference is made to FIGS. 3-8B, which illustrate example embodiments of composite plaster panels of the disclosure. FIG. 3 illustrates the layered structure of an example composite plaster panel 300. The composite plaster panel 300 comprises the basic core composite panel structure, including a foam core 310 sandwiched between a first fiber mesh reinforced cementitious (or other protective) layer 320 and a second fiber mesh reinforced cementitious (or other protective) layer 330. A plaster layer 340 is formed over the second fiber mesh reinforced cementitious (or other protective) layer 330, which forms the show side, i.e., that will be visible as the interior wall surface before applying a desired finish, such as paint and/or wallpaper. The plaster layer 340 in this embodiment is shown as having a textured surface that provides the look of rough plaster. It will be appreciated that the plaster layer 340 can have any desired surface finish, including smooth to very smooth, including a level 5 finish, which is a substantial improvement over traditional gypsum drywall panels.

The fiber mesh reinforced cementitious layers 320, 330 provide several advantages. The textured surface of the second fiber mesh reinforced cementitious layer 330 can enhance the bond strength of the plaster layer 340 and prevent delamination. Because the first fiber mesh reinforced cementitious layer 320 does not include a finish layer it can have a textured surface that facilitates adhesion of the composite plaster panel 300 to wall frame studs, ceiling joints, or other underlying structure using an adhesive or glue. In addition, the first and second fiber mesh reinforced cementitious (or other protective) layers 320, 330 provide high strength, which permits the composite plaster panel 300 to support relatively heavy loads, such as pictures, television sets, or other appliances using nails or screws, particularly if they can penetrate through both the first and second fiber mesh reinforced cementitious (or other protective) layers 320, 330.

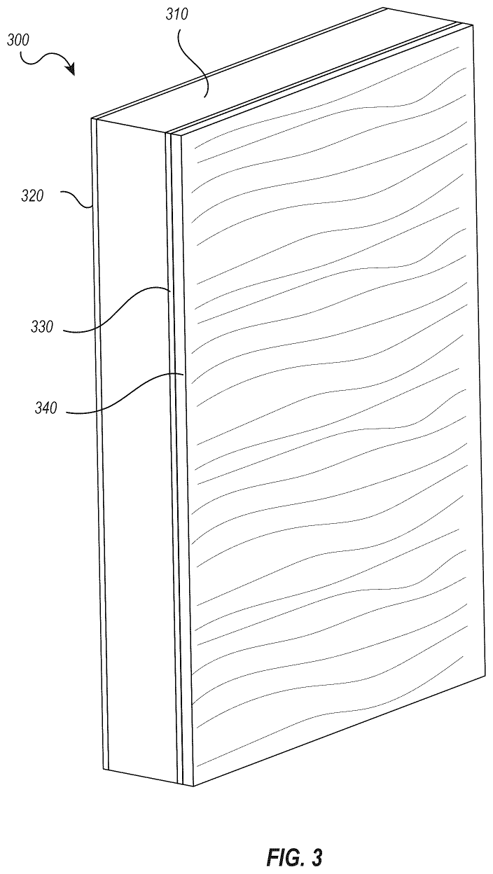

FIGS. 4A-4C illustrate another embodiment of a composite plaster panel 400 made from a core composite panel structure with a smooth plaster layer formed over the exposed or show side. The composite plaster panel 400 comprises the core composite panel structure, including a foam (e.g., polymer) core 410 sandwiched between first and second fiber mesh reinforced cementitious (or other protective) layers 420, 430. A plaster layer 440 is formed over the second fiber mesh reinforced cementitious (or other protective) layer 430, which forms the show side that will be visible as the interior wall surface before applying a desired finish, such as paint or wallpaper. The plaster layer 440 in this embodiment has a smooth surface finish. It will be appreciated that the plaster layer 440 can have any desired surface finish, including smooth to very smooth, including having a level 5 finish, which is a substantial improvement over traditional gypsum drywall panels.

The textured surface of the second fiber mesh reinforced cementitious layer 430 can enhance the bond strength of the plaster layer 440, which prevents delamination. The first fiber mesh reinforced cementitious (or other protective) layer 420 can have a textured surface that facilitates adhesion of the composite plaster panel 400 to wall frame studs, ceiling joists, or other underlying structure. The first and second fiber mesh reinforced cementitious (or other protective) layers 420, 430 provide high strength, which permits the composite plaster panel 400 to support relatively heavy loads, such as pictures, television sets, or other appliances using nails or screws, particularly if they can penetrate through both the first and second fiber mesh reinforced cementitious (or other protective) layers 420, 430.

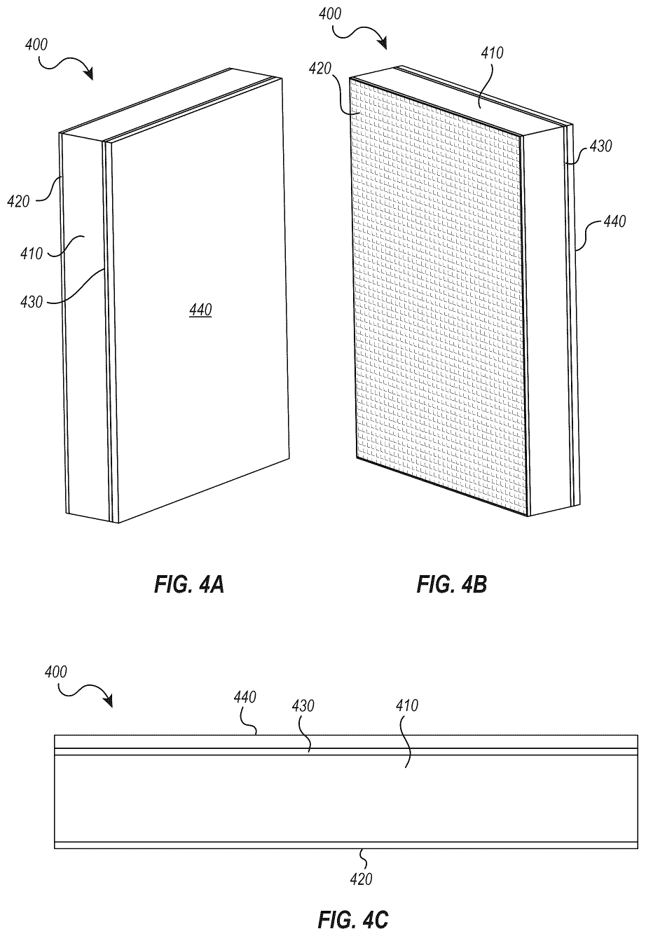

FIGS. 5-7B illustrate composite plaster panels 500, 600, 700 having beveled edges. FIG. 5 schematically illustrates a composite plaster panel 500 having four beveled edges 544, one in each of the four sides, and a plaster layer 540 covering the entire upper surface, beveled edges 544, and side ends 546. The plaster layer 540 over the beveled edges 544 can be applied over beveled portions of a fiber mesh reinforced cementitious layer (not shown) that extend over the foam core (not shown) in the region of the beveled edges 544 to provide the beveled edges 544 with a smooth finish and additional strength.

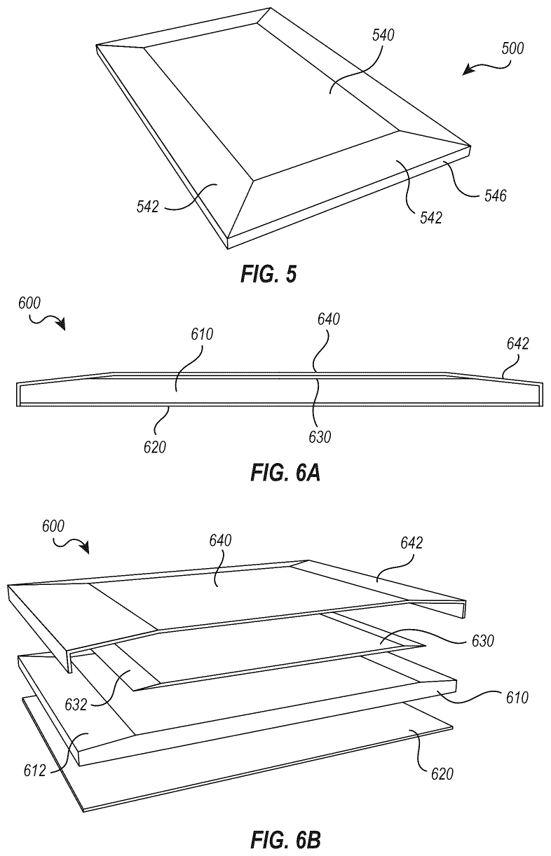

FIG. 6A is a side cross-sectional view, and FIG. 6B is an exploded view, showing the layered structure of an embodiment of a composite plaster panel 600. As illustrated in FIG. 6A, the composite plaster panel 600 includes a foam (e.g., polymer) core 610, a first fiber mesh reinforced cementitious (or other protective) layer 620 on an interior side, a second fiber mesh reinforced cementitious (or other protective) layer 630 on an exterior side, and a plaster layer 640 formed over the second fiber mesh reinforced cementitious (or other protective) layer 630. The composite plaster panel 600 includes beveled edges 644, with a beveled portion 614 of the foam core 610 being partially covered by a believed portion 634 of the second fiber mesh reinforced cementitious layer 630, which in turn is covered by a beveled portion of the plaster layer 640. In this way, the beveled edges 644 can have similar strength as the non-beveled portion of the composite plaster panel 600, which permits using nails, screws, or other fastening means to fasten the composite plaster panel 600 to wall frame studs, ceiling joists, or other structural elements through the beveled edges 644.

FIG. 6B is an exploded view of the composite plaster panel 600 that more particularly illustrates the layered structure. The composite plaster panel 600 includes a polymer foam core 610, a first fiber mesh reinforced cementitious (or other protective) layer 620, which can include a first cementitious layer with embedded first fiberglass mesh (not shown), a second fiber mesh reinforced cementitious (or other protective) layer 630, which can include a second cementitious layer with embedded second fiberglass mesh (not shown), and a plaster layer 640 formed over the second fiber mesh reinforced cementitious (or other protective) layer 630. The composite plaster panel 600 also includes beveled edges 644, which includes a beveled portion 614 of the polymer foam core 610 partially covered by a beveled portion 634 of the second fiber mesh reinforced cementitious (or other protective) layer 530, which are both covered by the beveled portion 644 of the plaster layer 640.

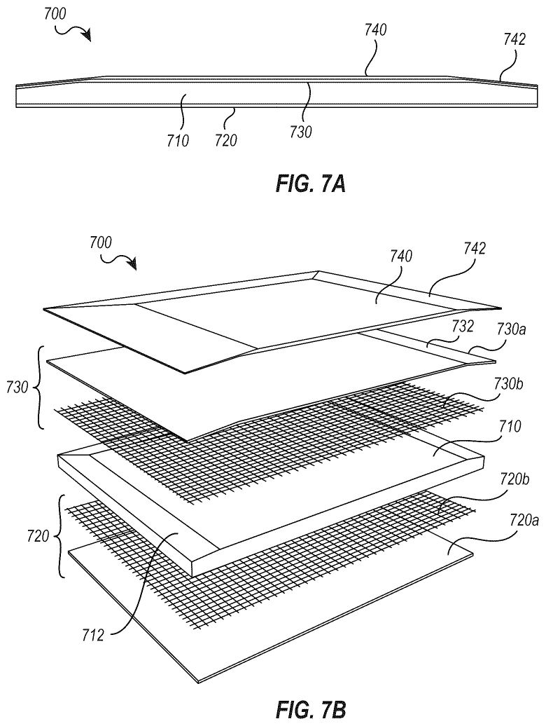

FIG. 7A is a side cross-sectional view, and FIG. 7B is an exploded view, showing the layered structure of another embodiment of a composite plaster panel 700. As illustrated in FIG. 7A, the composite plaster panel 700 includes a foam (e.g., polymer) core 710, a first fiber mesh reinforced cementitious (or other protective) layer 720 on an interior side, a second fiber mesh reinforced cementitious (or other protective) layer 730 on an exterior side, and a plaster layer 740 formed over the second fiber mesh reinforced cementitious (or other protective) layer 730. The composite plaster panel 700 includes beveled edges 742, with a beveled portion of the foam core 710 being entirely covered by a believed portion of the second fiber mesh reinforced cementitious layer 730, which in turn is covered by a beveled portion of the plaster layer 740. In this way, the beveled edges 742 can have the same reinforcement and strength as the non-beveled portion of the composite plaster panel 700, which permits using nails, screws, or other fastening means to fasten the composite plaster panel 700 to wall frame studs, ceiling joists, or other structural elements through the beveled edges 742.

FIG. 7B is an exploded view of the composite plaster panel 700 that more particularly illustrates the layered structure. The composite plaster panel 700 includes a polymer foam core 710, a first fiber mesh reinforced cementitious layer 720, which includes a first cementitious layer 720a with embedded first fiberglass mesh 720b, a second fiber mesh reinforced cementitious layer 730, which includes a second cementitious layer 730a with embedded second fiberglass mesh 730b, and a plaster layer 740 formed over the second fiber mesh reinforced cementitious layer 730. The composite plaster panel 700 also includes beveled edges 742, which includes a beveled portion of the polymer foam core 710 entirely covered by a beveled portion of the second fiber mesh reinforced cementitious layer 730, which is entirely covered by a beveled portion of the plaster layer 740.

In some embodiments, it may be desirable to apply and finish the plaster layer of the composite plaster panels disclosed herein in a manner that provides what is known in the industry as a “level 5” finish, or “drywall finish level 5”. A level 5 finish is defined by the Gypsum Association, the trade association for drywall professionals. The Gypsum Association has codified a set of professional standards that define the process of finishing drywall into five distinct levels. The following definitions are given for comparison. A level 0 finish means that no drywall finishing of any type has been done. At this level, the drywall boards are simply fastened to the walls or ceiling. A level 1 finish means that drywall joint tape has been embedded in the joint compound at the seams or joints, with no further finishing. A level 2 finish means that a skim coat of joint compound has been applied over the tape and to cover drywall screw holes. A level 3 finish means that a drywall finisher has applied a coat of joint compound to the tape and screws. Walls that will receive a heavy texture can end at this level, as progressing beyond this level of smoothness is unnecessary since texturing will produce a finish that is rougher than level 3. A level 4 finish is the classic drywall finish. This is achieved by applying another coat of joint compound to the tape and screws and sanding the dried compound. A level 4 finish is typically used when a surface is painted or covered with wallpaper. A level 5 finish is the highest possible level of drywall finishing and involves applying a skim coat, if applicable. A level 5 finish is achieved by applying another skim coat of joint compound (or mud) to a level 4 finish and then fine sanded. A level 5 finish is desirable when the applied finish will have glossy, enamel, or non-textured flat paint or when the light will be angled low enough to highlight bumps and depressions.

A level 5 finish is a premium finish that typically commands a much higher cost than lower level finishes. Providing a lightweight composite drywall board having a plaster coating that already provides a level 5 finish can eliminate the many steps and time required to prepare ordinary drywall to have a level 5 finish, particularly the need to apply a skim coat over the exposed paper surfaces of gypsum panels forming a wall or ceiling. This saves labor costs and time, including the time required for each coat of joint compound to dry and then be sanded.

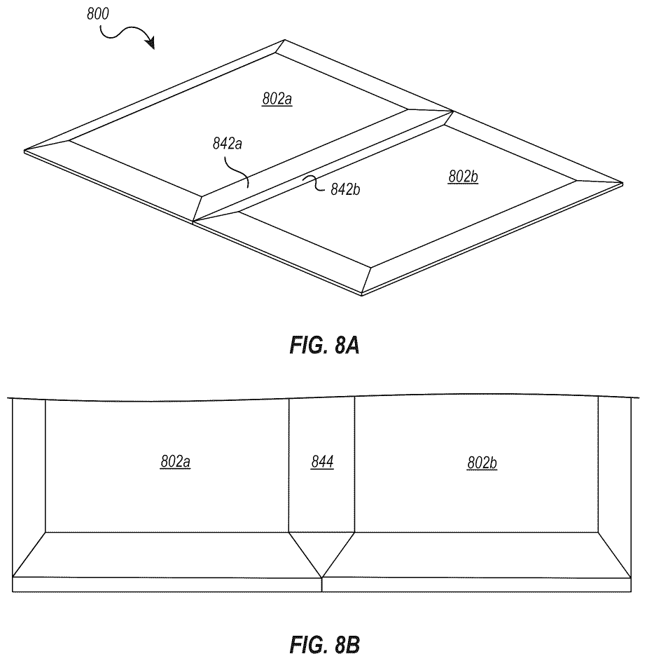

FIG. 8A illustrates two composite plaster panels 800 positioned side-by-side and abutting each other, each having a plaster layer 802a, 802b and beveled edges 842a, 842b that are aligned to facilitate application of tape and drywall patch to hide the seam and join the composite drywall boards 800 together, as illustrated in FIG. 8B. FIG. 8A shows the beveled edges 842a, 842b covered by a portion of the plaster layers 802a, 802b, while FIG. 8B shows the beveled edges 842a, 842b hidden beneath a plaster coating (e.g., drywall patch or joint compound) 844 such that the two composite plaster panels 800 have been joined together to yield a finished, seamless plaster surface finish. A level 5 finish can be achieved in a minimal number of steps by taping and plastering only the beveled edges 842a, 842b, followed by sanding the joint. Skim coating and sanding of the non-beveled portions of the plaster layers 802a, 802b is not required if they already have a factory applied level 5 finish.

FIG. 8B illustrate two lightweight composite drywall boards 800 positioned side-by-side and abutting each other, with beveled edges 834 aligned so as to permit the application of tape and drywall patch to join them together, as illustrated in FIG. 8C. FIG. 8B shows the beveled edges 834 as also being covered by a portion of the plaster layer 832, while FIG. 8C shows the beveled edges 834 hidden beneath a plaster coating (e.g., drywall patch) such that the two lightweight composite drywall boards 800 have been joined together to yield a finished, seamless plaster surface finish 832.

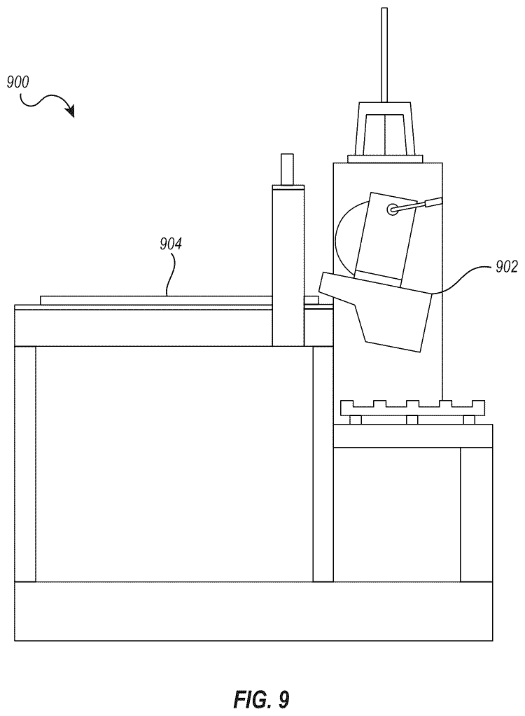

FIG. 9 illustrates an example beveling apparatus 900 with a beveling tool 902 used to grind or cut bevels into the sides of a partially constructed core composite panel structure 904 prior to applying the second fiber mesh reinforced cementitious (or other protective) layer and the plaster layer. As illustrated in FIGS. 7A and 7B, the bevels can be formed in a core composite panel structure 700 by removing a portion of the foam core 710 to form beveled regions, which can be covered by the second fiber mesh reinforced cementitious layer 730 to maximize strength in the beveled region, and then be covered by the plaster layer 740 to form the finished beveled edges 732. Thus, the beveling apparatus can make beveled edges in an uncoated side of the polymer foam core 710, followed by applying the second fiber mesh reinforced cementitious layer 730 on the beveled side, which is allowed to at least partially harden, followed by applying the plaster layer 740 over the second cementitious layer 730 to form composite layered beveled edges 742. The composite layered beveled edges 742 provide substantially greater strength for receiving screws, nails, or other mechanical fastening means known in the art.

In some embodiments, a fresh plaster composition used to form the plaster layer comprises mixture products of water, hydraulic cement, preferably white cement, calcium carbonate, aluminum oxide, silicon dioxide, cellulose ether, and latex. The fresh plaster composition may optionally include supplementary cementitious materials (SCMs), such as ground granulated blast furnace slag (GGBFS), fly ash, natural pozzolan, silica fume, microsilica, metakaoline, ground glass, calcined clay, finely ground quartz, limestone powder, and the like. The cementitious composition may include other components, such as natural hydraulic lime, calcium silicate, and/or expanded glass, which can increase fire and heat resistance.

In a more particular embodiment, the fresh plaster composition used to form one or more plaster layers can be formed by mixing together the following components (expressed in weight percent) to form a fresh, flowable plaster composition, which is applied to one or both sides of the core composite panel structure, and then allowed to harden or cure:

| | |
|---|---|
| Hydraulic cement | 30-50% |
| Calcium carbonate | 40-70% |
| Aluminum oxide (Al₂O₃) | 1-3% |
| Silicon dioxide | 4-8% |
| Calcium oxide | 2-5% |
| Hydroxypropyl | 0.2-06% |
| methylcellulose | |
| Latex powder | 2-4% |
| Water | (0.5 to 1.5, or 0.75 to 1.25, or 1 part |
| | water per 2.5 parts of dry ingredients) |

The hydraulic cement typically includes Portland cement, preferably white cement for aesthetic reasons, but may also include supplementary cementitious materials (SCMs), such as ground granulated blast furnace slag (GGBFS), fly ash, natural pozzolan, silica fume, microsilica, metakaoline, ground glass, calcined clay, finely ground quartz, and the like. The Portland cement comprises ground cement clinker interground with gypsum for set control and limestone as a filler. For aesthetic reasons, SCMs, when included, are preferably white or light colored. The silicon dioxide can be 150 mesh ground quartz sand. The latex powder can be redispersible 558 latex, which can be an ethylene/vinyl acetate copolymer, vinyl acetate/versatate copolymer, acrylic copolymer, etc. The latex powder can improve adhesion of the plaster layer to a cementitious layer.

The dry components of the plaster composition, known euphemistically as “putty powder”, can be dry mixed in a mixer to form an evenly mixed dry blend. Then the water is added to the mixture to form a fresh flowable plaster composition that can be sprayed. A spray gun is used to apply the fresh plaster composition to the fiber mesh reinforced cementitious layer of a basic lightweight composite wallboard (e.g., with or without beveled edges). The amount of plaster composition applied should be sufficient to cover the fiber mesh reinforced cementitious layer so that the grid-like texture is no longer visible, forming a smooth surface (or surface having a desired texture). The plaster composition is then allowed to cure for 7 days to form a hardened surface, which can be polished if desired to yield a smooth surface.

In some embodiments it may be desirable to cut the beveled edges to a width of about 1.5 inches (e.g., 1-2 inches, or 1.25-1.75 inches). If any portion of the composite plaster panels includes exposed expanded polystyrene foam, a primer can be used to cover the exposed polystyrene foam to enhance strength and improved the bond of drywall patch to the composite plaster panels.

Advantages of the composite plaster panels disclosed herein include: being lightweight (i.e., approximately ⅓ the weight of gypsum drywall panels and approximately ⅙ the weight of cement board); 100% waterproof as a result of the core being high density closed cell foam; high strength, high thermal insulation (i.e., proving approximately 4 times greater insulation than gypsum drywall), adequate soundproofing, and textured outer layer ideal for applying cement and glue for additional products. Further, due to the two layers of fiber reinforced cementitious composition, one on each side, a nail or screw entering both external layers can hold significant weight, substantially more weight than gypsum board.

Other advantages include the following:

Benefits from being Lighter Weight than Drywall:
a. delivery to site is cheaper; can ship 3 times more per truckload to the site;
b. easier to carry panels around job site because ⅓ the weight;
c. lower labor due to light weight; doesn't require two people to carry and hang panels.
   Benefit from being Waterproof:
a. no shrinkage from moisture on site (meaning if it rains on a pile of drywall awaiting use, they often have to throw away the top layer, or some of rest if water entered sides);
b. no mold risk, and less likely to have to be torn out and replaced if there is a leak in the house.
   Benefits from Just not being Dusty Gypsum:
a. Less likely to crack or break if dropped;
b. no gypsum dust.
   Benefits from Insulation:
a. four times higher R-value;
b. Some sound reduction.

### Stronger:

a. less likely to be damaged during construction transportation and handling;
b. advantages in roofing applications (discussed below);
c. performs as a structural panel for prescriptive braced walls or shear walls.

### Weather Resistant:

a. very low freeze and thaw deformation, rate of 0.014% (relevant to outdoor applications).

### Additional Terms & Definitions

While certain embodiments of the present disclosure have been described in detail, with reference to specific configurations, parameters, components, elements, etcetera, the descriptions are illustrative and are not to be construed as limiting the scope of the claimed invention.

Furthermore, it should be understood that for any given element of component of a described embodiment, any of the possible alternatives listed for that element or component may generally be used individually or in combination with one another, unless implicitly or explicitly stated otherwise.

In addition, unless otherwise indicated, numbers expressing quantities, constituents, distances, or other measurements used in the specification are to be understood as optionally being modified by the term “about” or its synonyms. When the terms “about,” “approximately,” “substantially,” or the like are used in conjunction with a stated amount, value, or condition in the specification and claims, it may be taken to mean an amount, value or condition that deviates by less than 20%, less than 10%, less than 5%, less than 1%, less than 0.1%, or less than 0.01% of the stated amount, value, or condition. At the very least, and not as an attempt to limit the application of the doctrine of equivalents to the scope of the claims, each numerical parameter should be construed in light of the number of reported significant digits and by applying ordinary rounding techniques.

Any headings and subheadings used herein are for organizational purposes only and are not meant to be used to limit the scope of the description or the claims.

It will also be noted that, as used in this specification and the appended claims, the singular forms “a,” “an” and “the” do not exclude plural referents unless the context clearly dictates otherwise. Thus, for example, an embodiment referencing a singular referent (e.g., “widget”) may also include two or more such referents.

It will also be appreciated that embodiments described herein may also include properties and/or features (e.g., ingredients, components, members, elements, parts, and/or portions) described in one or more separate embodiments and are not necessarily limited strictly to the features expressly described for that particular embodiment. Accordingly, the various features of a given embodiment can be combined with and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include such features.

1. A composite plaster panel, comprising:
a core composite panel structure comprised of:
a foam core having a first surface and a second surface opposite the first surface;
a first protective layer selected from a first fiber reinforced cementitious layer, thermoset polymer layer, or magnesium oxide layer formed over and covering at least a portion of the first surface of the foam core; and
a second protective layer selected from a second fiber reinforced cementitious layer, thermoset polymer layer, or magnesium oxide layer formed over and covering at least a portion of the second surface of the foam core; and
a plaster layer applied to and at least partially covering at least one side of the core composite panel structure.

2. The composite plaster panel of claim 1, wherein at least one of the first or second fiber reinforced cementitious layers is included and comprises fiber reinforcement embedded within a hardened cementitious composition comprising reaction products of a fresh cementitious composition comprising mixture products of water, Portland cement, silicon dioxide, calcium oxide, and gypsum hemihydrate.

3. The composite plaster panel of claim 2, wherein the fiber reinforcement is selected from fiber mesh, alkali-resistant fiberglass mesh, embedded fibers, fabric, woven, scrim, felt, and non-woven, wherein the fiber reinforcement comprise at least one of plant fibers, polymer fibers, and inorganic fibers, which are selected from fibers or filaments formed from glass, basalt, rock wool, or carbon.

4. The composite plaster panel of claim 2, wherein the fresh cementitious composition comprises mixture products of water, hydraulic cement, silicon dioxide, calcium oxide, iron oxide, gypsum hemihydrate, water-reducing agent, defoamer, styrene, and acrylic acid or polymer thereof, optionally at least one supplementary cementitious material (SCM) selected from the group consisting of ground granulated blast furnace slag (GGBFS), fly ash, natural pozzolan, silica fume, microsilica, metakaoline, ground glass, calcined clay, and finely ground quartz, and optionally at least one of natural hydraulic lime, calcium silicate, or expanded glass.

5. The composite plaster panel of claim 2, wherein the fresh cementitious composition comprises mixture products of:

| | |
|---|---|
| hydraulic cement | 30-50% |
| silicon dioxide | 40-60% |
| calcium oxide | 2-5% |
| iron oxide | 0.2-1% |
| gypsum hemihydrate | 3-8% |
| water-reducing agent | 0.2-0.6% |
| defoamer | 0.2-0.6% |
| styrene | 1-2% |
| acrylic acid | 1-2% |
| water | 15-22% of dry ingredients. |

6. The composite plaster panel of claim 2, wherein the at least one of the first or second fiber reinforced cementitious layers has a cross-sectional thickness in a range of about 0.5 mm to about 3 mm, or about 0.75 mm to about 2.5 mm, or about 1 mm to about 2 mm, or about 1.25 mm to about 1.75 mm.

7. The composite plaster panel of claim 1, wherein at least one of the first or second thermoset polymer layers is included and comprises polyurea or polyaspartic and is optionally fiber-reinforced.

8. The composite plaster panel of claim 7, wherein the at least one of the first or second thermoset polymer layers has a cross-sectional thickness in a range of about 1 mm to about 5 mm, or about 2 mm to about 4 mm.

9. The composite plaster panel of claim 1, wherein the plaster layer comprises reaction products of water, hydraulic cement, preferably white cement, calcium carbonate, aluminum oxide, silicon dioxide, cellulose ether, and latex.

10. The composite plaster panel of claim 1, wherein the plaster layer comprises reaction products of

| | |
|---|---|
| hydraulic cement | 30-50% |
| calcium carbonate | 40-70% |
| aluminum oxide (Al₂O₃) | 1-3% |
| silicon dioxide | 4-8% |
| calcium oxide | 2-5% |
| hydroxypropyl | 0.2-06% |
| methylcellulose | |
| latex powder | 2-4% |
| water | (0.5 to 1.5, or 0.75 to 1.25, or 1 part |
| | water per 2.5 parts of dry ingredients) |

11. The composite plaster panel of claim 1, wherein the composite plaster panel includes beveled edges, and wherein the plaster layer at least partially covers the beveled edges.

12. The composite plaster panel of claim 1, wherein at least a portion of the plaster layer has a textured surface.

13. The composite plaster panel of claim 1, wherein at least a portion of the plaster layer has a smooth surface, optionally a level 5 finish.

14. The composite plaster panel of claim 1, wherein the composite plaster panel includes a single plaster layer, wherein a side of the composite plaster panel opposite the single plaster layer has a textured exterior surface.

15. The composite plaster panel of claim 1, wherein the foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure.

16. The composite plaster panel of claim 1, wherein the foam core comprises an inorganic foam material selected from the group consisting of silica gel, aerogel, silicate foams, urea-silicate foams, SiOC/SiC, ceramic foams, and refractory foams.

17. A composite plaster panel, comprising:
a core composite panel structure comprised of:
a polymer foam core having a first surface and a second surface opposite the first surface;
a first protective fiber mesh reinforced cementitious layer formed over and covering at least a portion of the first surface of the polymer foam core; and
a second protective fiber mesh reinforced cementitious layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein each of the first and second protective fiber mesh reinforced cementitious comprises fiberglass mesh embedded within a hardened cementitious composition comprising reaction products of a fresh cementitious composition comprising water, Portland cement, silicon dioxide, calcium oxide, and gypsum hemihydrate; and
a plaster layer applied to and at least partially covering at least one side of the core composite panel structure.

18. A composite plaster panel, comprising:
a core composite panel structure comprised of:
a polymer foam core having a first surface and a second surface opposite the first surface;
a first protective thermoset polymer layer formed over and covering at least a portion of the first surface of the polymer foam core; and
a second protective thermoset polymer layer formed over and covering at least a portion of the second surface of the polymer foam core,
wherein the polymer foam core comprises a polymer selected from the group consisting of extruded polystyrene (XPS), expanded polystyrene (EPS), polyisocyanurate, polyurethane (PUR), phenolic polymers (e.g., phenol-formaldehyde), melamine polymers (e.g., melamine-formaldehyde), and other thermoplastic and thermoset polymers that can be formed into a rigid or semi-rigid polymer foam structure,
wherein the first and second thermoset polymer layers are independently selected from polyurea and polyaspartic and are optionally fiber-reinforced; and
a plaster layer applied to and at least partially covering at least one side of the core composite panel structure.

19. A method of manufacturing a composite plaster panel as in claim 1, comprising:
providing the core composite panel structure; and
forming the plaster layer over at least one side of the core composite panel structure, wherein the plaster layer is formed by applying a fresh plaster composition over at least one side of the core composite panel structure and causing or allowing the fresh plaster composition to harden or cure,
wherein the fresh plaster composition comprises mixture products of water, hydraulic cement, preferably white cement, calcium carbonate, aluminum oxide, silicon dioxide, cellulose ether, and latex.

20. The method of claim 19, wherein the fresh plaster layer comprises mixture products of

| | |
|---|---|
| hydraulic cement | 30-50% |
| calcium carbonate | 40-70% |
| aluminum oxide (Al₂O₃) | 1-3% |
| silicon dioxide | 4-8% |
| calcium oxide | 2-5% |
| hydroxypropyl | 0.2-06% |
| methylcellulose | |
| latex powder | 2-4% |
| water | (0.5 to 1.5, or 0.75 to 1.25, or 1 part |
| | water per 2.5 parts of dry ingredients) |
